(19) United States
(12) Patent Application Publication
(10) Pub. No.: US 2024/0223050 A1
(43) Pub. Date: Jul. 4, 2024

(54) Device for Grounding Electrical Currents of a Rotor Shaft of an Electric Machine

(71) Applicant: ZF Friedrichshafen AG, Friedrichshafen (DE)

(72) Inventor: Michael Wetterau, Salem (DE)

(21) Appl. No.: 18/292,520

(22) PCT Filed: Jul. 4, 2022
(86) PCT No.: PCT/EP2022/068388

§ 371 Date: Jan. 26, 2024

(30) Foreign Application Priority Data
Jul. 27, 2021 (DE) 10 2021 208 058.8

(51) Int. Cl. H02K 11/40

(52) U.S. Cl. CPC H02K 11/40

(57) ABSTRACT

A device for drawing off electric currents from a rotor shaft of an electric machine comprises an electrically conductive contact pin (2) axially movably arranged in a guide sleeve (1) and pressed onto the rotor shaft by an electrically conductive spring arrangement provided in the guide sleeve (1). The guide sleeve (1) having a contact surface for electrical connection to the stator of the electric machine. The spring arrangement configured as a parallel connection of two electrically conductive helical springs (4, 5) wound in opposite directions and forming a counter-coil.

### CROSS-REFERENCE TO RELATED APPLICATIONS

The present application is related is a U.S. national phase application of PCT/EP2022/068388 filed on Jul. 4, 2022 and has right of priority to German Patent Application No. DE102021208058.8 filed on Jul. 26, 2021, both of which are incorporated by reference in their entirety for all purposes.

### TECHNICAL FIELD

The present invention relates generally to a device for drawing off currents from a rotor shaft of an electric machine.

### BACKGROUND

In electrified drive trains, due to the electric machine, an undesirable, parasitic current flow arises across the rotor shaft. This parasitic current can be divided into a high-frequency component (capacitive displacement current) having few mA and a low-frequency component (circular machine current) having multiple amperes. Both the high-frequency component and the low-frequency component have a negative effect on the quality of the products, since the high-frequency component, inter alia, can interfere with other electronic components, for example, radios, wherein the low-frequency component can damage bearings and mechanical components and greatly reduce the service life of the drive.

Since the parasitic current flow cannot be avoided, possibilities are known from the prior art for specifically conducting the current flow or for guiding the current flow along the shortest path back to the source of interference, in order to thereby minimize the damaging and interfering effects. For example, bearings are known, which are deliberately exposed to the current flow and become worn in order to protect other components. It is also known to use shaft-sealing rings made of conductive nonwoven fabric, shaft-grounding rings and shaft-grounding pins, in order to specifically conduct the parasitic current flow.

DE 10 2016 213 653 A1 makes known a discharge device for dissipating electrical disturbances, in particular currents, from a rotor part of a machine, which is designed, in particular, as a shaft, into a stator part of the machine, the discharge device having a contact device which includes a contact element, which is axially slidably accommodated in a guide device, the contact element being acted upon by a contact force device in order to form a shaft contact force for electrical contact between a shaft contact surface of the contact element and a rotor contact surface of the shaft. The guide device has a stator contact surface for electrical connection to the stator part and the discharge device has a guide contact force device for generating a guide contact force between a guide contact surface of the contact element and the stator contact surface, which is electrically connected to the stator part. Due to this design, the contact element, which is designed as a pin, is pressed onto the rotor shaft by the contact force device, which is designed as a helical spring, and, in this way, offers a discharge path to the parasitic current.

The impedance of the discharge path is determined by the impedance of the pin, which is made of conductive material, and the impedance of the helical spring. At high frequencies, the inductive component of the helical spring comes into play and decisively determines the total impedance; therefore, the discharge device operates primarily in the lower frequency range.

Furthermore, EP 2 140 526 A1 describes a tapping device for tapping a voltage from a shaft of an electric machine, wherein the tapping device has a brush holder, which is made of electrically conductive material and is connectable to a main body of the electric machine. The known tapping device has a brush, which is made of electrically conductive material, wherein the brush holder has a brush guide in which the brush is movably guided, such that the brush is pressable against the shaft via a spring force. The brush is electrically conductively connected to the brush holder, wherein an electrically insulating intermediate element is arranged between the brush and the brush guide, such that no direct electrical contact occurs between the brush and the brush guide.

### BRIEF SUMMARY

Example aspects of the present invention provide a device for drawing off electric currents from a rotor shaft of an electric machine.

Accordingly, example aspects of the invention relate to a device for drawing off electric currents from a rotor shaft of an electric machine, the device having an electrically conductive contact pin, which is axially movably arranged in a guide sleeve and is pressed onto the rotor shaft by the force of an electrically conductive spring arrangement provided in the guide sleeve, the guide sleeve having a contact surface for electrical connection to the stator of the electric machine, and the spring arrangement being designed as a parallel connection of two electrically conductive helical springs wound in opposite directions and forming a counter-coil.

Due to the design according to example aspects of the invention, the advantage is achieved that the inductance of the spring arrangement is only one quarter (¼) of the inductance of the spring arrangement known from the prior art including a helical spring having the same inductance as the inductance of the individual coils of the spring arrangement according to example aspects of the invention, which results in the device according to example aspects of the invention for drawing off electric currents from a rotor shaft of an electric machine operating not only in the lower frequency range, but also above a considerably higher frequency range due to the lower impedance.

Preferably, the helical springs wound in opposite directions have the same inductance.

### BRIEF DESCRIPTION OF THE DRAWINGS

Example aspects of the invention are explained in greater detail by way of example in the following with reference to the attached figures, wherein only those features are described in detail that are relevant for example aspects of the present invention and the same reference characters are used for identical components, wherein:

FIG. 1: A schematic sectional view of a device designed according to the prior art for drawing off electric currents from a rotor shaft of an electric machine, and the corresponding electrical equivalent circuit; and

FIG. 2: A schematic sectional view of a device designed according to example aspects of the invention for drawing off electric currents from a rotor shaft of an electric machine, and the corresponding electrical equivalent circuit.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

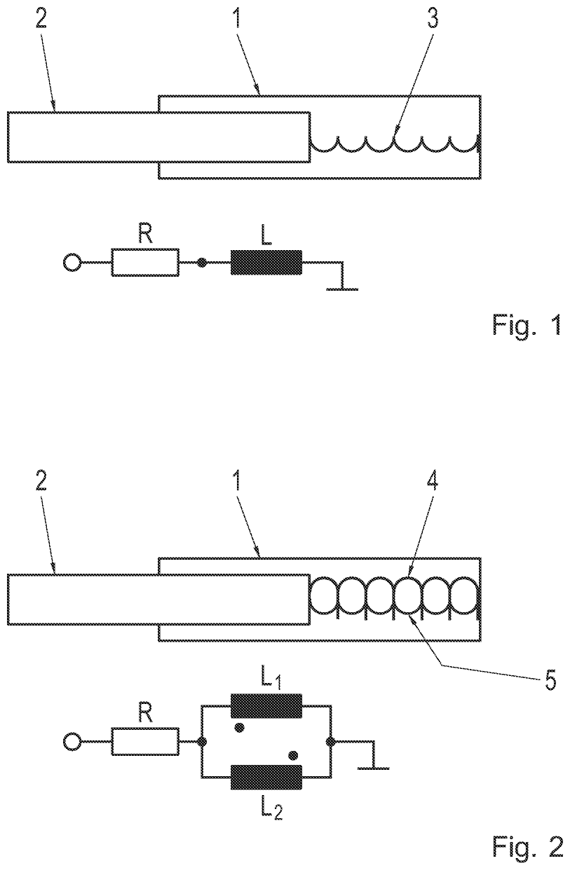

FIG. 1 shows a device designed according to the prior art for drawing off electric currents from a rotor shaft of an electric machine. The device includes an electrically conductive contact pin 2, which is axially movably arranged in a guide sleeve 1 and is pressed onto the rotor shaft (not shown) by the force of an electrically conductive helical spring 3 provided in the guide sleeve 1; the guide sleeve 1 has a contact surface for electrical connection to the stator of the electric machine. The electrical equivalent circuit of this arrangement is shown in the lower part of FIG. 1; this is a series circuit of an ohmic resistor R and a coil having the inductance L.

According to example aspects of the invention and with reference to FIG. 2, a device is provided for drawing off electric currents from a rotor shaft of an electric machine, the device having an electrically conductive contact pin 2, which is axially movably arranged in a guide sleeve 1 and is pressed onto the rotor shaft by the force of an electrically conductive spring arrangement provided in the guide sleeve 1. The contact pin 2 can be made, for example, of graphite.

The guide sleeve 1 has a contact surface for electrical connection to the stator of the electric machine. According to example aspects of the invention, the spring arrangement is designed as a parallel connection of two electrically conductive helical springs 4, 5 wound in opposite directions, having the inductances L1 and L2, respectively, and forming a counter-coil.

With reference to the lower part of FIG. 2, which is the electrical equivalent circuit of the arrangement according to example aspects of the invention, it is apparent that the inductance of the spring arrangement, due to the parallel connection of the two helical springs 4, 5 wound in opposite directions, is only one quarter (¼) of the inductance of the spring arrangement known from the prior art according to FIG. 1 including a helical spring 3 having the same inductance as the inductance L1, L2 of the individual coils of the spring arrangement according to example aspects of the invention.

This results in the advantage that currents having a high-frequency component can also be drawn off by the device according to example aspects of the invention for drawing off electric currents from a rotor shaft of an electric machine.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

1 guide sleeve
2 contact pin
3 helical spring
4 helical spring
helical spring
R ohmic resistor
L inductance
L1 inductance
L2 inductance

1-3: (canceled)

4. A device for drawing off electric currents from a rotor shaft of an electric machine, the device comprising:
a guide sleeve (1) comprising a contact surface for electrical connection to the stator of the electric machine;
an electrically conductive spring arrangement provided in the guide sleeve (1);
an electrically conductive contact pin (2) axially movably arranged in the guide sleeve (1) and pressed onto the rotor shaft by the spring arrangement,
wherein the spring arrangement comprises a parallel connection of two electrically conductive helical springs (4, 5) wound in opposite directions and forming a counter-coil.

5. The device of claim 4, wherein the two helical springs (4, 5) wound in opposite directions have the same inductance.

6. The device of claim 4, wherein the contact pin (2) is made of graphite.
